(19) United States
(12) Patent Application Publication
(10) Pub. No.: US 2010/0065178 A1
(43) Pub. Date: Mar. 18, 2010

(54) CARCASS PLY FOR A PNEUMATIC TIRE

(76) Inventors: Serge Julien Auguste Imhoff, Grand Duchy (LU); Yves Donckels, Natoye (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/210,355

(22) Filed: Sep. 15, 2008

(51) Int. Cl. B60C 9/11

(52) U.S. Cl. 152/451

(57) ABSTRACT

A pneumatic tire includes a carcass reinforced by a carcass ply, at least one belt ply disposed radially outward of the carcass ply in a crown portion of the pneumatic tire, and at least one insert located adjacent the carcass ply in a sidewall portion of the carcass. The insert provides support for the tire load to enable the pneumatic tire to operate under extreme conditions. The carcass ply comprises at least one composite cord having a first core yarn with a second outer yarn and an outer metallic filament both wrapped around the first core yarn such that the first core yarn has a modulus less than a combined modulus of the second outer yarn and the outer metallic filament.

### FIELD OF THE INVENTION

The present invention is directed towards a runflat or non-runflat pneumatic tire. More specifically, the present invention is directed towards a pneumatic tire wherein a carcass reinforcement layer is comprised of a high energy hybrid, cord.

### BACKGROUND OF THE INVENTION

A conventional hybrid cord, for use as an overlay in pneumatic tires, is formed of two different materials: a low initial modulus core yarn and high modulus wrap yarns. The selection of the yarns is such that the “break point” of the cord (i.e., when the slope of the force versus elongation curve changes from a relatively low slope to a relatively high slope) occurs between 2%-3% elongation, with an ultimate cord break at over 5% elongation. Another conventional hybrid overlay cord is formed of aramid and nylon twisted together, wherein the break point of the cord occurs between 4%-6% elongation, with an ultimate cord break at over 10% elongation. In an overlay, the hoop reinforcing effects of a strong cord are desired. However, the hybrid cord must have elongation properties to permit the tire to expand into a toroidal shape during tire molding.

A conventional run-flat tire has two carcass reinforcing plies and reinforcing wedge inserts in the tire sidewalls. The wedge inserts resist radial deflection of the tire with a combination of compressive and bending stresses in both the inflated, as well as uninflated, conditions. In the uninflated condition, runflat tires experience a net compressive load in the region of the sidewall closest to the road-contacting portion of the tire. The outer portions of the sidewall experience tensile forces while the inner portions of the sidewall undergo compression stresses during bending. The conventional runflat tire balances the necessary flexibility in the inflated condition with the necessary rigidity in the uninflated condition by employing two reinforcing carcass plies. The axially outermost ply has cords with a modulus of elasticity that increases with strain. The axially innermost ply has cords with a modulus that exceeds that of the outermost ply during normal loads in an inflated condition. Thus, the innermost ply supports the majority of the load during normal operation, while the outermost ply only support a minority of the load.

When the conventional tire is operated in an uninflated condition, the load is shifted from the axially innermost ply to the axially outermost ply and again the plies do not equally contribute to the support of the load. The outermost ply thereby does not contribute to the overall rigidity of the tire sidewall during normal operation in the inflated condition.

Another conventional runflat tire has a single carcass ply and at least one insert located adjacent the carcass ply in a sidewall portion. The insert provides support for the tire load to enable the tire to operate in an uninflated condition. The carcass ply comprises a composite cord with at least two first yarns twisted helically about at least one second yarn. The first yarns and the second yarn have different modulus of elasticity. The first yarns have a modulus greater than a modulus of the second yarn.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25.degree. 65.degree. angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Circumferential” means lines or directions extending along the perimeter of the surface of the annular tire parallel to the Equatorial Plane (EP) and perpendicular to the axial direction.

“Cord” means one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“High Tensile Steel (HT)” means a carbon steel with a tensile strength of at least 3400 Mpa@0.20 mm filament diameter.

“Inner” means toward the inside of the tire and “outer” means toward its exterior.

“LASE” is load at specified elongation.

“Lateral” means an axial direction.

“Lay length” means the distance at which a twisted filament or strand travels to make a 360.degree. rotation about another filament or strand.

“Radial” and “radially” are used to mean directions radially toward or away from the axis of rotation of the tire.

“Sidewall” means that portion of a tire between the tread and the bead.

“Super Tensile Steel (ST)” means a carbon steel with a tensile strength of at least 3650 Mpa@0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Tread” means a molded rubber component which, when bonded to a tire casing, includes that portion of the tire that comes into contact with the road when the tire is normally inflated and under normal load.

“Ultra Tensile Steel (UT)” means a carbon steel with a tensile strength of at least 4000 Mpa@0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF THE INVENTION

A pneumatic tire in accordance with the present invention includes a carcass reinforced by a carcass ply, at least one belt ply disposed radially outward of the carcass ply in a crown portion of the pneumatic tire, and at least one insert located adjacent the carcass ply in a sidewall portion of the carcass. The insert provides support for the tire load to enable the pneumatic tire to operate under extreme conditions. The carcass ply comprises at least one composite cord having a first core yarn with a second outer yarn and an outer metallic filament both wrapped around the first core yarn such that the first core yarn has a modulus less than a combined modulus of the second outer yarn and the outer metallic filament.

In another aspect of the present invention, the first core yarn is selected from the group consisting of: rayon, nylon, polyamide 6 and 6,6, PET, PK, and PEN.

In still another aspect of the present invention, the second outer yarn is selected from the group consisting of: aramid, PK, PBO, carbon fiber, glass fiber, and ceramic.

In yet another aspect of the present invention, wherein the outer metallic filament is selected from the group consisting of: Super, Ultra, and Mega tensile steels, titanium, and aluminum.

In still another aspect of the present invention, wherein the second outer yarn has a linear density value in the range of 550 to 3300 dtex.

In yet another aspect of the present invention, wherein the first core yarn has a linear density value in the range of 940 dtex to 3680 dtex.

In still another aspect of the present invention, the cord has a structure of core yarns versus outer yarns and filaments selected from the group consisting of: 1/2, 2/2, 3/2, 1/3, 2/3, 3/3, and 4/3.

In yet another aspect of the present invention, the carcass ply has an end count of cord ends per inch in the range of 15-32 (5.9-12.6 ends per cm).

In still another aspect of the present invention, the first core yarn is rayon and the second outer yarn is aramid.

A reinforcement structure for a pneumatic tire in accordance with the present invention includes at least one composite cord having a first core yarn with a second outer yarn and an outer metallic filament both wrapped around the first core yarn such that the first core yarn has a modulus less than a combined modulus of the second outer yarn and the outer metallic filament.

### BRIEF DESCRIPTION OF THE DRAWINGS

The invention will be described by way of example and with reference to the accompanying drawings in which:

FIG. 1 is a schematic representation of cross sectional view of an example tire for use with the present invention; and

FIG. 2 is a schematic representation of an example cord construction in accordance with the present invention.

### DETAILED DESCRIPTION OF AN EXAMPLE OF THE PRESENT INVENTION

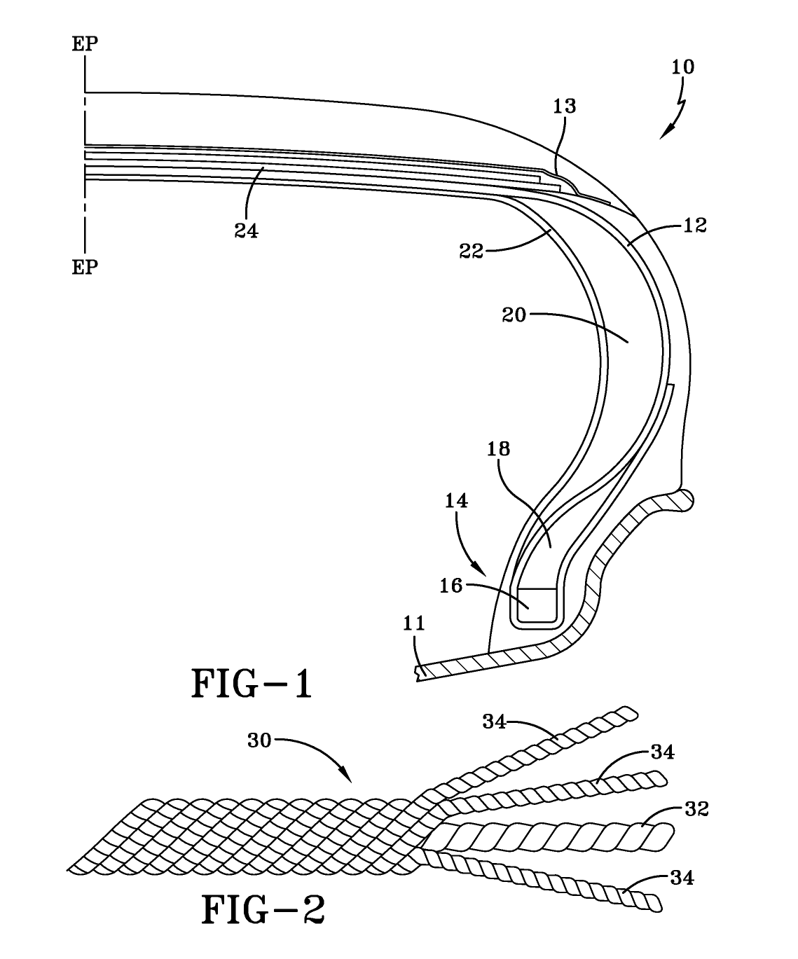

FIG. 1 is a cross-sectional view of an example pneumatic tire 10 for use with the present invention. The example tire 10 is mounted on a tire rim 11, designed to be capable of continued operation during inflated and uninflated conditions. Only one half of the tire 10 is shown, it being understood that, the other half is a mirror image of that which is illustrated. The example tire 10 has a single reinforcing carcass ply 12 extending from one bead area 14 of the tire to an opposing bead area (not shown). The ends of the carcass ply 12 are turned axially inward to axially outward about bead cores 16 and bead apexes 18. Terminal ends of the carcass ply 12 extend past radially outer ends of the bead apexes 18 thereby enveloping the bead apexes.

Located in each sidewall region of the example tire 10 is a sidewall insert 20. The sidewall insert 20 may be alternatively disposed adjacent to a tire innerliner 22 (FIG. 1) or axially outward of the carcass ply 12 (not shown). The sidewall insert 20 may be formed of elastomeric material and may extend from a crown area of the example tire 10, from radially inward of a belt reinforcement structure 24 to radially inward of terminal ends of the bead apexes 18. The elastomeric material of the sidewall insert 20, or wedge, may be selected to provide the example tire 10 with support during uninflated, or runflat, operation of the tire.

The belt reinforcement structure 24, disposed radially outward of the carcass ply 12, may have at least two inclined, crossed cord plies. The cords of the inclined plies are inclined with respect to a circumferential direction of the example tire 10. The cords of radially adjacent plies may further be inclined at similar, but opposing, angles to each other.

Outward of the belt reinforcement structure 24 may be an overlay 13. The overlay 13 may have an axial width equal to, or greater than, a maximum axial width of the crossed cord plies of the belt reinforcement structure 24, thereby encapsulating the crossed cord plies between the overlay 13 and the carcass ply 12. The overlay may be reinforced with cords inclined at angles of 0°-15° relative to an equatorial plane EP of the example tire 10.

In accordance with the present invention, the carcass ply 12 may be formed from at least one cord 30 as seen in FIG. 2. The cord 30 is a composite, or hybrid, cord made of yarns and metallic filaments of appropriate stress-strain characteristics to provide a runflat or high performance tire, such as the example tire 10, with additional sidewall bending resistance when the tire operates in a run-flat, high speed, or other extreme condition. In accordance with this “High-Energy Cord” concept, the cord 30 may be formed of at least one low modulus core yarn 32 about which is twisted an outer component 34 of at least one brass-plated metallic filament and at least one high modulus yarn. The construction of the cord 30 allows the lower modulus core yarn (32 in FIG. 2) of the cord 30 to work at relatively low strain (i.e., an inflated, normally operated condition) until the cord has reached a specific allowable elongation. From this point, the high modulus outer component (34 in FIG. 2) will be under tension (i.e., an uninflated or high speed inflated condition) and may limit the stretch of the cord 30 and bending of the sidewall portion of the carcass ply 12.

Materials for the low modulus core yarn(s) 32 may include, but are not limited to, rayon, nylon polyamide 6 and 6,6, polyethylene terephthalate (PET), and polyethylene napthalate (PEN). Materials for the high modulus outer yarn(s) may include, but are not limited to, polyethylene ketone (PK), polyphenylene-2,6-benzobisoxazole (PBO), polyester, and polyvinyl alcohol (PVA). Materials for the high modulus outer metallic filament(s) may include, but are not limited to, Super Tensile Steel, Mega Tensile Steel, Ultra Tensile Steel, titanium, and aluminum.

Material selection is based on the desired stress/strain characteristics of the hybrid cord 30 as a whole. However, a main criteria is that the outer wrap metallic filament/yarn component(s) 34 have moduli greater than the core yarn(s) 32. Thus, for example, the outer wrap metallic filament/yarn component(s) 34 may be Super tensile steel and PK with rayon core yarn(s) or the outer wrap metallic filament/yarn component(s) may be titanium and PBO with polyamide 6 core yarn(s).

The number of low modulus core yarns 32 may be no greater than five while the number of high modulus outer wrap metallic filament/yarn components may be no greater than ten. For example, the number of low modulus core yarns 32 versus high modulus outer wrap metallic filament/yarn components 34 in the cord 30 may be, but is not limited to, 1/2, 2/2, 3/2, 1/3, 2/3, 3/3 or 4/3. FIG. 2 illustrates a 1/3 construction with a single core yarn 32 and three outer wrap filament/yarn components 34.

To obtain the desired strength characteristics of the cord 30 that enable the cord to support a tire during a regular inflated mode, the core yarn(s) 32 may have a linear density value in the range of 940 dtex to 3680 dtex, including PET 1100, 1440, 1670 & 2200 dtex and/or rayon 1220, 1840 & 2440 dtex by way of specific, but not limiting, examples. The outer wrap yarns may have a linear density value in the range of 550 dtex to 3300 dtex, including 1100 & 1670 dtex fiber by way of specific, but not limiting, examples. The outer wrap metallic filaments may have any suitable diameter and strength, such as 0.08 mm-0.41 mm diameter of Super, Ultra, or Mega tensile steel, for providing a high modulus and thermally resistant component to the outer wrap component(s) 34 of the cord 30.

In the example cord 30, each of the core yarn 32 and outer filament/yarn components 34 may have its components twisted together a given number of turns per unit of length, usually expressed in turns per inch (TPI). Additionally, the core yarns 32 and the outer filament/yarn components 34 may each be twisted together a given number of turns per unit of length (TPI) for the yarns and lay lengths, such as between 3 mm and 25 mm, for the filaments of the cord 30. The direction of twist refers to the direction of slope of the spirals of a yarn, metallic filament, or cord when it is held vertically.

Visually, if the slope of the spirals appears to conform in direction to the slope of a letter “S”, then the twist is termed “S” or “left handed”. If a slope of the spirals appears to visually conform in direction to the slope of a letter “Z”, then the twist is termed “Z” or “right handed”. An “S” or “left handed” twist direction is understood to be a direction opposite to a “Z” or “right handed” twist. “Twist” is understood to mean the twist imparted to a yarn or filament/yarn component before the yarn or filament/yarn component is incorporated into a cord. “Cord twist” is understood to mean the twist imparted to two or more yarns and filaments/yarns when twisted together with one another to form the cord. “dtex” is understood to mean the weight in grams of 10,000 meters of a yarn before the yarn has a twist imparted thereto.

One example of a cord 30 (FIG. 2) in accordance with the present invention may include, but is not limited to, the following construction: 1100/1+(1840/1×0.20 mm UT/1)/3, twisted 10Z/(10.4Z/7S)/3S (meaning that one core yarn of 1100 dtex has a twist of 10 TPI in the Z direction; one outer yarn of 1840 dtex has a twist of 10.4 TPI in the Z direction, one outer metallic filament of 0.20 mm diameter Ultra Tensile steel (strength of 4000 MPa@0.20 mm); one outer yarn and one metallic filament are twisted together for an intermediate twist of 7 TPI in the S direction; and, after three twisted outer filament/yarn components are wrapped about the twisted 1100 dtex core yarn, the four yarn and yarn/filament components receive an overall cord twist of 3 TPI in the S direction).

The low modulus core yarn 32 of the example cord 30 may be rayon and the high modulus yarn of the outer filament/yarn component 34 may be aramid. In selecting a cord structure, the core yarn(s) 32 and outer filament/yarn component(s) 34 have no preferred specific strength ratio. As stated above, a main criteria has the modulus value of the outer filament/yarn component(s) and core yarn(s) differing such that a cord structure responds properly under differing loads and tire operations, such as inflated and uninflated conditions or normal speed and high speed conditions.

Cords in accordance with the present invention, such as the example cord 30 of FIG. 2, may have overall diameters in the range of 0.5 mm-2.0 mm. When calendering these cords, the ends per inch (EPI) of the hybrid cord may be in the range of 15-32 EPI (5.9-12.6 ends per cm, epcm).

Thus, a single carcass ply of hybrid cords (i.e., 30) in accordance with the present invention may reduce overall weight of the tire, while also simplifying construction of a run-flat or high performance tire. The monoply carcass structure, when formed of these hybrid cords, provides the necessary performance and support to a run-flat tire during both inflated and under-inflated operating conditions and also to a high performance tire during both normal speed and high speed conditions. Further, the carcass ply may incur temperatures in excess of 150 degrees Celsius during runflat or high speed conditions. Use of outer cord materials with excellent thermal stability, such as aramid and steel, allows the sidewall portions of the carcass ply to maintain strength under these extreme temperatures.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising:
a carcass reinforced by a carcass ply;
at least one belt ply disposed radially outward of the carcass ply in a crown portion of the pneumatic tire; and
at least one insert located adjacent the carcass ply in a sidewall portion of the carcass, the insert providing support for the tire load to enable the pneumatic tire to operate under extreme conditions,
the carcass ply comprising at least one composite cord having a first core yarn with a second outer yarn and an outer metallic filament both wrapped around the first core yarn such that the first core yarn has a modulus less than a combined modulus of the second outer yarn and the outer metallic filament.

2. The pneumatic tire of claim 1 wherein the first core yarn is selected from the group consisting of: rayon, nylon, polyamide 6 and 6,6, PET, PK, and PEN.

3. The pneumatic tire of claim 1 wherein the second outer yarn is selected from the group consisting of: aramid, PK, PBO, carbon fiber, glass fiber, and ceramic.

4. The pneumatic tire of claim 1 wherein the outer metallic filament is selected from the group consisting of: Super, Ultra, and Mega tensile steels, titanium, and aluminum, with a filament diameter in the range of 0.08 mm to 0.41 mm.

5. The pneumatic tire of claim 1 wherein the second outer yarn has a linear density value in the range of 550 to 3300 dtex.

6. The pneumatic tire of claim 1 wherein the first core yarn has a linear density value in the range of 940 dtex to 3680 dtex.

7. The pneumatic tire of claim 1 wherein the cord has a structure of core yarns versus outer yarns and filaments selected from the group consisting of: 1/2, 2/2, 3/2, 1/3, 2/3, 3/3, and 4/3.

8. The pneumatic tire of claim 1 wherein the carcass ply has an end count of cord ends per inch in the range of 15-32 (5.9-12.6 ends per cm).

9. The pneumatic tire of claim 1 wherein the first core yarn is rayon and the second outer yarn is aramid.

10. A reinforcement structure for a pneumatic tire comprising at least one composite cord having a first core yarn with a second outer yarn and an outer metallic filament both wrapped around the first core yarn such that the first core yarn has a modulus less than a combined modulus of the second outer yarn and the outer metallic filament.
